(19) United States
(12) Patent Application Publication
(10) Pub. No.: US 2016/0100002 A1
(43) Pub. Date: Apr. 7, 2016

(54) RESOURCE ALLOCATION METHODS AND APPARATUS

(71) Applicant: SorsEm, LLC, Wilmington, DE (US)

(72) Inventors: William F. DIMONTE, Washington, DC (US); Nico A. DIMONTE, Washington, DC (US); Joseph DIMONTE, McLean, VA (US); Zach ARNSON-SEROTTA, Silver Spring, MD (US); Gregory L. LAUBACH, Bethesda, MD (US)

(21) Appl. No.: 14/872,524

(22) Filed: Oct. 1, 2015

Related U.S. Application Data
(60) Provisional application No. 62/059,324, filed on Oct. 3, 2014.

(51) Int. Cl. H04L 29/08; H04L 12/58; H04L 29/06

(52) U.S. Cl. CPC H04L 67/1014; H04L 67/42; H04L 51/24; H04L 67/1023

(57) ABSTRACT

A system, method and non-transitory computer-readable medium of instructions for provisioning resources employ a server. The server is configured to receive from a client device a request for a particular resource involving human manipulation of audio and/or visual information. The request includes resource information pertaining to a type of the resource, a date/time at which the resource is needed, and a location where the resource is needed. The server is further configured to evaluate respective criteria associated with each respective one of a plurality of potentially available resources to select one of the potentially available resources as a selected resource based on the respective criteria, send a client notification to the client device identifying the selected resource, and send to a device associated with the selected resource a resource notification indicating that the selected resource is selected as the particular resource.

### CROSS-REFERENCE TO RELATED APPLICATION

This application claimed benefit from U.S. Provisional Patent Application No. 62/059,324, filed on Oct. 3, 2014. The entire contents of U.S. Provisional Patent Application No. 62/059,324 is incorporated herein by reference.

### BACKGROUND OF THE INVENTION

1. Field of the Invention

The present invention relates to system, method and non-transitory computer readable medium of instructions for allocating resources. More particularly, the present invention relates to system, method and non-transitory computer readable medium of instructions that are operable to request, schedule or otherwise allocate resources.

2. Background Information

Typically, support agencies function as middlemen between requesters (e.g., individuals, companies or government agencies, or other entities that need resources) and resources. A requester, for instance, calls, emails, or faxes an agency with a service request for a resource. More recently, a requester may request a resource through a website or portal managed by the agency. The request generally includes a type of resource (e.g., court reporter, videographer, interpreter, multimedia expert, audio/visual expert, illustrator, notary public, process server, etc.), a location where the resource is needed (e.g., in court, meeting sites, convention site, law office, client site, etc.), and a date/time the resource is needed.

Once a service request has been made, a support agency assigns an appropriate resource based on the needs of the requester specified in the request. The majority of service requests are made 24 hours or more before the resource is needed to provide support for an assignment. However, some assignments are requested on short notice (e.g., a last minute cancellation of an already scheduled resource). In these short notice instances, the support agency calls, e-mails or texts any of the resources who they believe are available to cover the assignment. Depending on the arrangement, the resource controls their scheduling, production, and billing. Alternatively, the resource may outsource scheduling, production, and billing to a support agency at considerable cost.

Support agencies are mostly made up by small, family owned companies that provide services local to their headquarters. These smaller agencies generally employ or contract with less than 20 resources. There are also a few national support agencies that provide services throughout the continental US and abroad. These agencies tend to employ or contract with hundreds to thousands of resources. When their own resources are not available, the larger and smaller support agencies subcontract with other agencies to ensure that a service request is covered.

### SUMMARY OF THE INVENTION

The present disclosure provides a new and innovative system, method, and apparatus for allocating resources and, in particular, resources involving human manipulation of audio and/or visual information. The system, method, and apparatus provide a framework that provides a new dynamic for requesting, scheduling, or otherwise allocating resources. The system, method, and apparatus automatically locates resources for and other requesters based on matches with a number of predetermined factors (e.g., type, distance, affinity, etc.). The system, method, and apparatus facilitates the scheduling, production, and billing of resources to streamline the entire process.

In an exemplary embodiment, the system, method, and apparatus are used within a mobile application interface for smartphones and a web interface (collectively referred to herein as a resource management interface) for computers that are configured to connect to a hosted real-time availability database. The resource management interface enables requesters to locate qualified and/or certified resources for an assignment. The example database and corresponding processors manage the status and availability of resources. The example database and corresponding processors uses multiple service and convenience factors to determine potential matches for a requested service. An analytical scoring algorithm, for example, is configured to process input criteria of a request in conjunction with data within a user database and/or other data sources (e.g., current traffic reports, weather reports, etc.) to determine one or more best matching resources. A requester may select one of the best matching resources, which causes the example system to query the requester and/or resource for approval. The example system also schedules or otherwise tracks the travel of the resource to the requested service location.

The example system may also facilitate the matching of future job opportunities through a push notification feature. For instance, if a resource fits within given criteria, the resource is notified via push notification of the opportunity. The resource can choose to accept or decline the assignment. If the assignment is accepted by another resource, the assignment will no longer be available to accept. The system may also automate billing and deliverable production through a payment processor and/or local support agency, if requested by the independent contractor resource.

Additional features and advantages of the disclosed system, method, and apparatus are described in, and will be apparent from, the following Detailed Description and the Figures.

### BRIEF DESCRIPTION OF THE DRAWINGS

Referring now to the attached drawings which form a part of this original disclosure:

FIG. 1 shows an example of a resource allocation environment in which an exemplary embodiment of a resource allocation system, method and non-transitory computer readable medium of instructions can be used;

FIG. 2 shows an exemplary diagram of registration information that maybe provided to a server via an application of FIG. 1;

FIG. 3 shows an exemplary diagram of a user interface displayed by the application of FIG. 1 for a requester to create a service request;

FIGS. 4 to 7 show exemplary diagrams of an exemplary procedure for determining resources that match a request;

FIG. 8 shows an exemplary diagram of relationships between different data structures that are accessible by the server of FIG. 1;

FIG. 9 shows an exemplary diagram of a resource interface used within the environment shown in FIG. 1; and

FIG. 10 shows an exemplary diagram of a job-day context created by the server in the environment shown in FIG. 1 for a requester.

### DETAILED DESCRIPTION OF THE EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

The present disclosure relates in general to a method, apparatus, and system for allocating resources and, in particular, to a method, apparatus, and system that uses algorithmic matching to determine one or more resources that are qualified to handle a request. The exemplary method, apparatus, and system include a server that is configured to host a platform for processing requests, determining best matching resources, and facilitating the scheduling of a selected best matching resource. As discussed herein, a resource includes a professional that provides a service in support of an assignment. The resource may include, for example, a court reporter, a videographer, an interpreter, a multimedia expert, an audio/visual expert, an illustrator, notary public, process server, etc. Generally, the term “resource” can refer to any type of activity involving human manipulation of audio and/or visual information, such as the tasks performed by a court reporter, a videographer, an interpreter, a multimedia expert, an audio/visual expert, an illustrator, notary public, process server and so on, as can be appreciated by one skilled in the art. The “manipulation” can refer to the processing, operations and so on that are performed by the resource, such as performing court reporting, capturing and working with audio and/or visual information as a videographer, interpreting or translating languages as an interpreter, analyzing, explaining or otherwise working with audio and/or visual information as a multimedia expert or an audio/visual expert, preparing audio and/or visual information as an illustrator, reviewing and verifying documents as a notary public, obtaining documents and serving process as a process server, and so on. An assignment may include, for example, a preparation of materials, a presentation of materials during a proceeding, a recording of a proceeding, or translate portions of a proceeding.

Also disclosed herein, a requester includes an individual or entity that has a need for assistance with an assignment or task. The requester may include, for example, a professional, a conference coordinator, business consultant, or individual who requires the assistance of a resource and, in particular, a resource involving human manipulation of audio and/or visual information. The requester provides a service request to request a resource for an assignment and/or task. As disclosed herein, the service request identifies a type of resource needed, any special unique skills required (e.g., fluent in Chinese, expert in Powerpoint, types at least 100 words per minute, etc.), a geographic location where the resource is needed, and/or a date/time the resource is needed. The request may also specify a duration of the assignment, an estimated or proposed cost (e.g., a bid), payment structure (e.g., payment within 30 days of completion of the assignment) and any other information that may be useful for describing the nature of the assignment or useful to a resource for understanding the assignment

The requester may also include a support agency. For example, a support agency may use the method, apparatus, and system disclosed herein for managing their own resources and/or searching for third-party resources. In some embodiments, the support agency may use the method, apparatus, and system disclosed herein to make their own resources available to an outside requester.

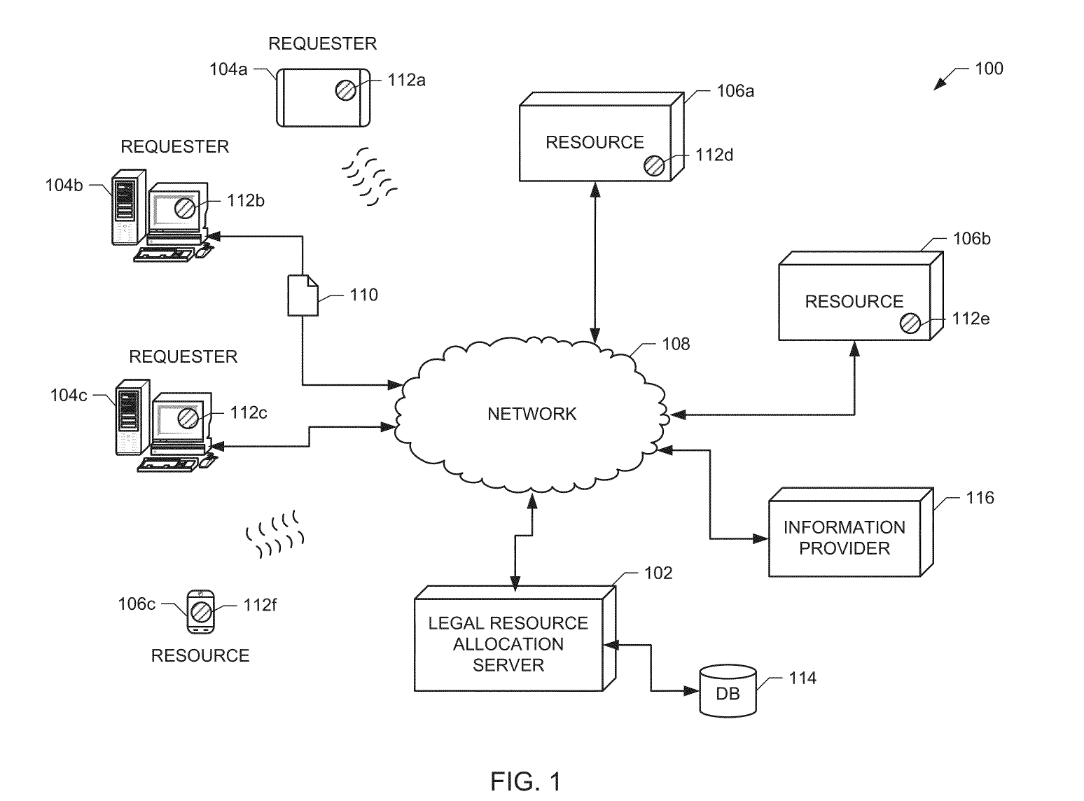

FIG. 1 shows an example of a resource allocation environment 100 in which an exemplary embodiment of a resource allocation system, method and non-transitory computer readable medium of instructions can be used. The environment 100 includes a resource allocation server 102 configured to host and/or manager a resource allocation service. The environment 100 also includes requester client devices 104 and resource devices 106 communicatively coupled to the server 102 via a network 108 (e.g., the Internet or any other suitable wireless and/or wired communication network). The requester client devices 104 and the resource devices 106 may include any smartphone, tablet computer, personal computer, laptop computer, workstation, processor, server, smartwatch, smart eyewear, etc. In the illustrated example of FIG. 1, the resource devices 106a, 106b, and 106c may include a server managed or operated by a support agency and/or an entity that manages/consults with resources.

The resource allocation server 102 is configured to host a platform that enables the requester client devices 104 to submit service requests 110 and resource devices 106 to view the requests and/or accept assignment proposals/requests. The server 102 may host or manage a website that enables the service requests 110 to be submitted as, for example, a web form, through an application programmable interface (“API”), and/or through a web portal. The server 102 may also facilitate the distribution of an application (e.g., an app) that provides an interface for submitting service requests 110, viewing requests, and accepting requests. The server 102 may be configured as a computer or any other suitable type of device configured to perform the operations described herein.

The resource allocation server 102 in this example is connected to a database 114 that is configured to store one or more data structures of data including requester/resource profile information, service requests, responses, scheduled assignments, etc. The database 114 may also store feedback regarding completed assignments, payment information/history, etc. In some instances, the resource allocation server 102 may use data stored in the database 114 to select a resource, determine a best matching resource, and/or recommend a resource.

The exemplary environment 100 also includes an information provider 116 configured to generate information useful to the server 102 for selecting a resource for a service request 110. For example, the information provider 116 may include a server that tracks/reports traffic/weather/news for a particular geographic area. The resource allocation server 102 may be configured to periodically access the information provider 106 for information. Alternatively, the information provider 106 may periodically transmit information to the server 102.

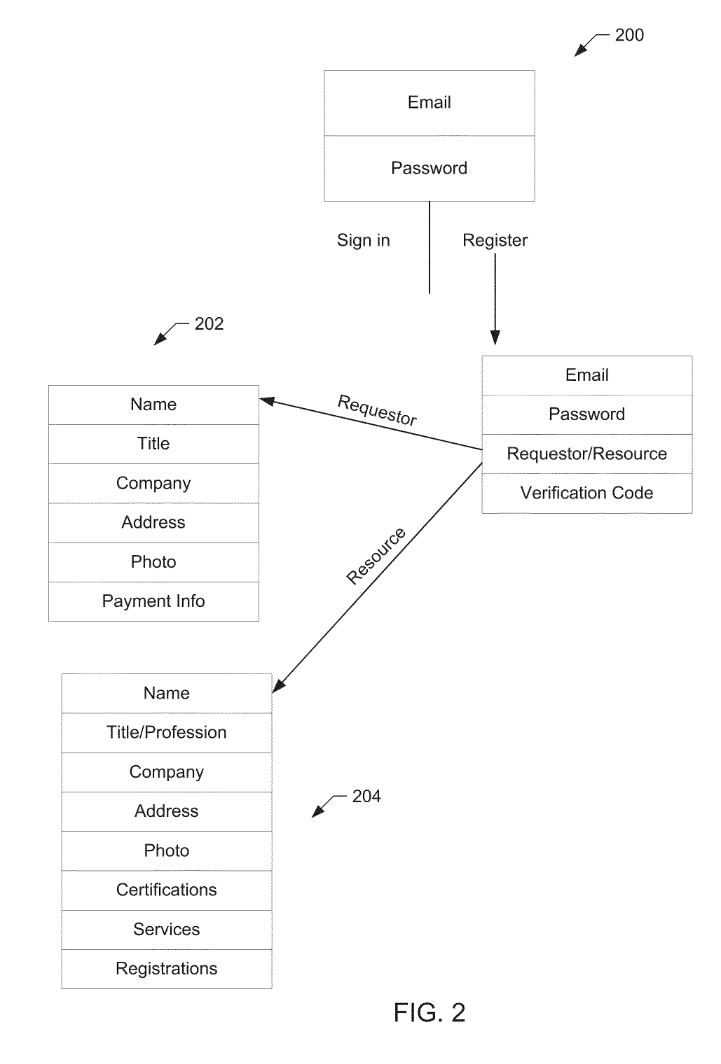

FIG. 2 shows a diagram of registration information 200 that may be provided to the server 102 via, for example, the application 112. After installing the application 112, the requester/resource is presented with a screen that requests an email login and password. Conditioned on the requester/resource not already having an account, the application 112 prompts the requester/resource for an email address, password, an indication as to whether the entity/individual registering is a requester or resource, and/or a verification code. The server 102 may transmit the verification code to a provided email address after the individual/entity registering requests the code and/or selects a register function.

Conditioned on the entity/individual selecting the requester option, the application 112 (or server 102) is configured to prompt the requester to complete data fields 202. In some instances, the data fields 202 may include boxes or fields on a web form. Alternatively, the data fields 202 may be programmable boxes or regions within a user interface of the application 112. The data fields 202 may include, for example, a name field, a title field, a company field, an address field, a photo field, and a payment info field. It should be appreciated that the payment info field may link to or use an API to access a third-party payment site for registering payment information.

Conditioned on the entity/individual selecting the resource option, the application 112 (or server 102) is configured to prompt the resource to complete data fields 204. The data fields include a name field, a title/profession field (e.g., court reporter, videographer, interpreter, notary public, process server, etc.), a company name field, an address, a photo, certifications/languages (e.g., CSR, RPR, RMR, RDR, CLR, CRR, etc.), services offered/areas of expertise (e.g., realtime, expedited, rough drafts, timestamps, technical/medical, anti-trust, etc.), and a registrations field (e.g., Pennsylvania, Maryland, etc.). It should be appreciated that some of the fields may be configured based on selections in other fields. For example, responsive to selecting ‘interpreter’ within the profession field, the exemplary certifications field may be limited to languages and levels of proficiencies. Resources may also request to be verified by the server 102 and/or an operator of the server 102.

In some instances, the resource may have more than one profession. In these instances, the resource may select more than one profession causing separate certifications/services/registrations fields to be displayed for each profession. The exemplary information provided by the requester in the data fields 202 and the resource in the data fields 204 are stored in the database 114 and used by the server 102 to determine which resource is to be selected for a particular service request from a requester.

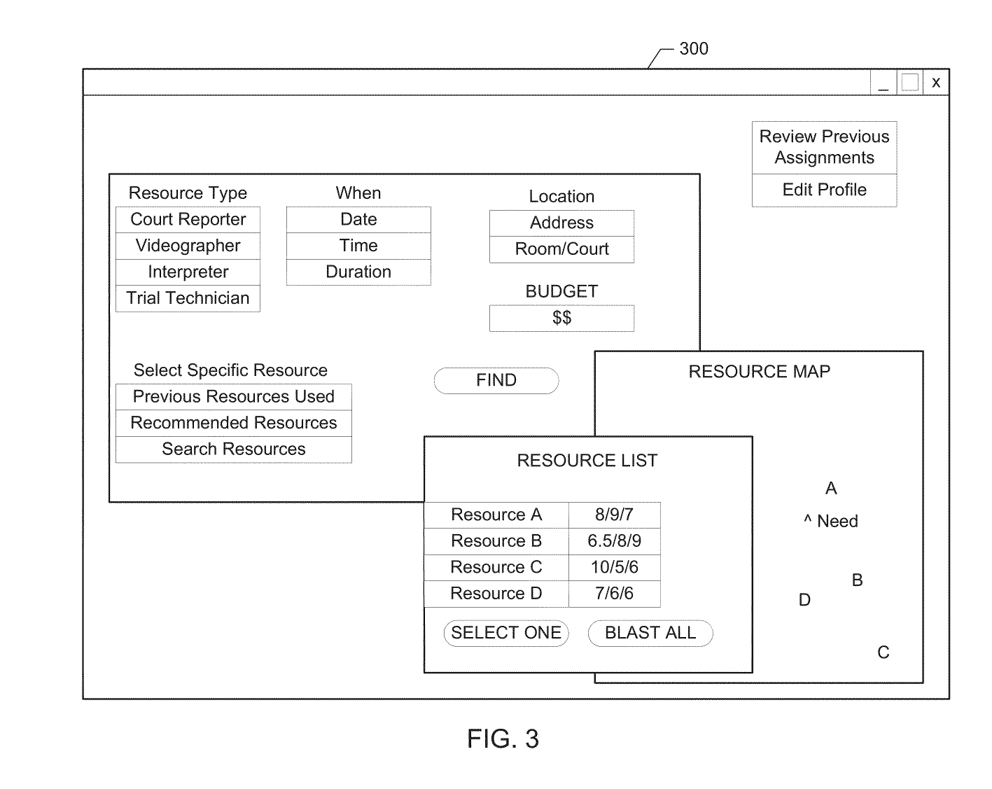

FIG. 3 shows a diagram of an exemplary user interface 300 displayed by the application 112 for a requester to create a service request 110. The user interface 300 includes a section 302 configured to enable a request to create a service request. The user interface 300 also includes options for a requester to view previous assignments and/or edit the profile information discussed in conjunction with the data fields 202 of FIG. 2. Section 302 shows one example as to how a requester may provide information for a service request. It should be appreciated that the fields may be changed, rearranged, and/or dynamic based on previous selections and/or a history of the requester.

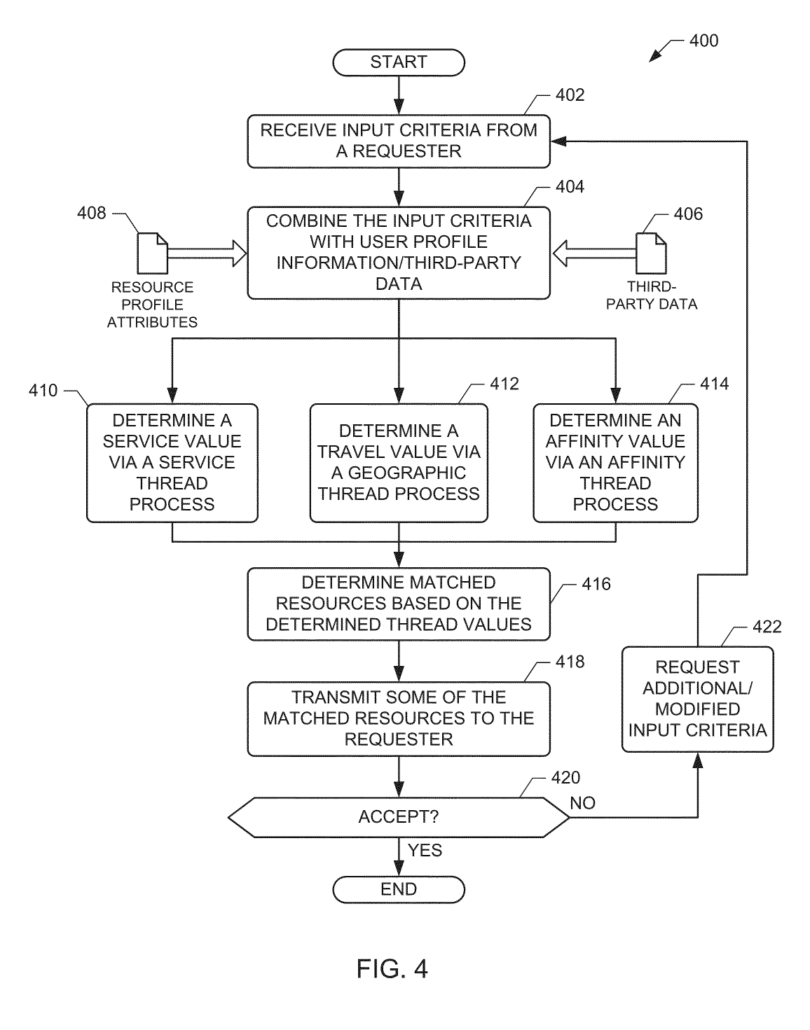

In the illustrated example, the section 302 includes fields for a resource type, a date/time, location, and budget. Responsive to selecting the resource type fields, the application 112 may display a prompt or other field that enables the requester to provide more detailed information. For instance, responsive to having the ‘interpreter’ field selected, the application 112 may select a list of languages available for selection. In another example, responsive to having the ‘court reporter’ field selected, the application 112 may provide a list of service types and/or certifications (e.g., proceeding, deposition, words/minute threshold, etc.). The budget field enables the requester to specify how much the requester is willing to pay for the work performed. In other instances, the budget option may be replaced by and/or supplemented with an option for the requester to accept bids for the work. Once at least some of the fields are filled in with input criteria, the requester selects the “Find” button which causes the server 102 to determine one or more resources that match the provided criteria. An exemplary process for determining matching resources is described in conjunction with FIGS. 4 to 7.

Section 302 also includes a feature than enables the requester to search for a specific resource. For instance, the requester may select the resource type and then select the previous resources used field, causing the application 112 to display a list of previous resources used that correspond to the selected resource type. The requester may also view recommended resources that are determined by the server 102. For instance, the server 102 may compile a data structure of resources for each requester that are anticipated as being a good match based, for example, on high ratings by friends/colleagues of the requester, within a same immediate geographical region as the requester, and/or resources that have a similar profile as other resources used by the requester in the past.

### Flowchart of the Exemplary Process

FIGS. 4 to 7 illustrate flow diagrams showing an exemplary procedure 400 determine one or more resources that match input criteria provided by a requester, according to an exemplary embodiment. Although the procedure 400 is described with reference to the flow diagrams illustrated in FIGS. 4 to 7, it should be appreciated that many other methods of performing the steps associated with the procedure 400 may be used. For example, the order of many of the blocks may be changed, certain blocks may be combined with other blocks, and many of the blocks described are optional. Further, the actions described in procedure 400 may be performed among multiple devices including, for example the server 102, the client device 104 and/or the resource device 106.

The exemplary procedure 400 of FIG. 4 operates on, for example, the resource allocation server 102 of FIG. 1. The procedure 400 begins when the server 102 receives input criteria (e.g., a service request 110) from a client device 102 of a requester (block 402). The server 102 augments the input criteria with previously stored user profile information and/or data from third-party information sources (block 404). The augmenting of the input criteria includes, for example, combining resource profile attributes (e.g., the information with data fields 202) with the input criteria. The allocation server 102 is also configured to pull third-party databases for data (e.g., traffic information, weather, etc.) via one or more APIs or other interfaces.

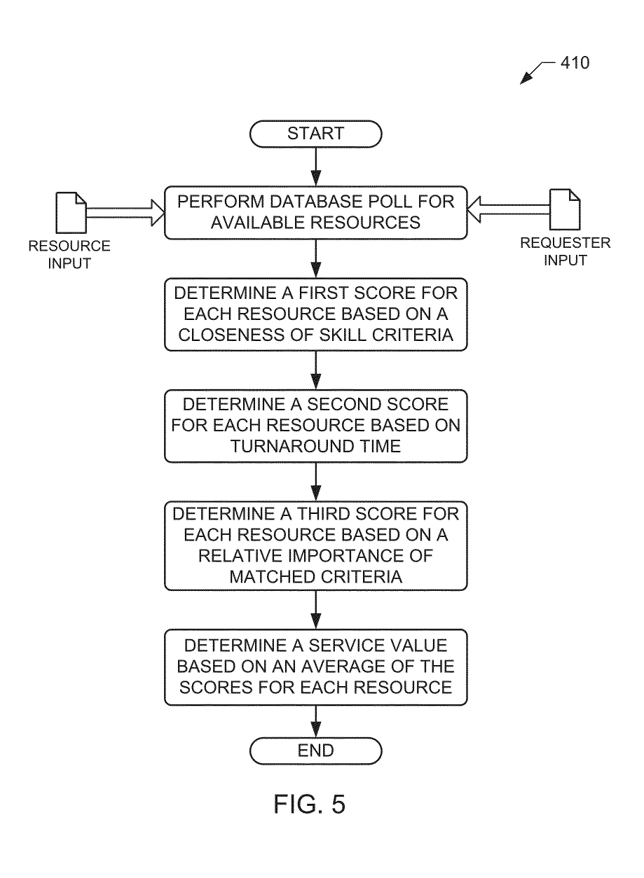

The procedure 400 next processes three separate threads to analyze aspects of the input criteria with respect to different resource attributes and third-party information (blocks 410, 412, and 414). In a first thread (block 410) the server 102 determines a service (or skills) value that compares the abilities requested by the requester with the availability of resources that have the ability (e.g. Realtime or Expedite for a Court Reporter, video-to-text synchronization service for a Videographer, language and area of expertise for an interpreter, and state of certification for a notary or process server etc.). FIG. 5 shows an exemplary procedure 410 to determine the service value, including, for example, accessing the input criteria (e.g., requester input) and the attributes of the resources. The procedure 410 also includes determining a first score for each resource based on a closeness to a requested skill criteria, determining a second score for each resource based on a turnaround time for that resource, and determining a third score for each resource based on a relative importance of each of the matching criteria for the skills and turnaround time. The procedure 410 then averages the first, second, and third scores to determine a service value. In some instances, the scores may be weighted using coefficients determined through feedback analysis and/or requester/resource feedback.

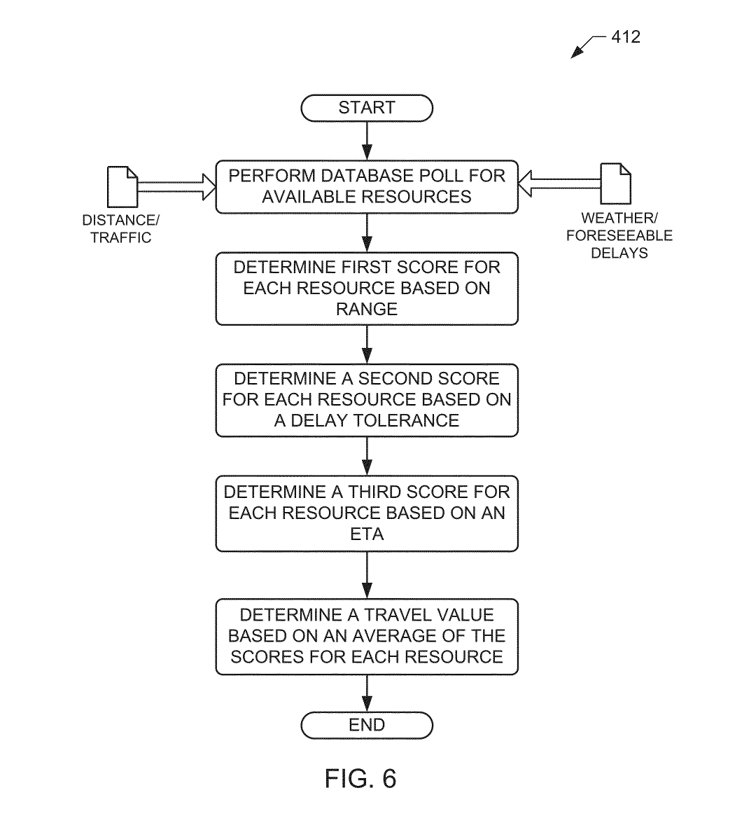

In a second thread (block 412), the server 102 determines a travel value that corresponds to a relative location between each resource and a job site. The travel value is based, in part, on a distance between the job site and the resource, traffic (or estimated traffic) at the time before the job is to begin, weather, and/or en-route delays such as impeding rush hour or an incoming weather system. The information used to determine the travel value may also be used to provide the requester with an accurate ETA for the requester. FIG. 6 shows an exemplary procedure 412 to determine the travel value, including, for example, accessing the third party information including traffic, weather, distance information, and/or foreseeable delays. The procedure 412 also includes determining a first score for each resource based on a range of the resource (e.g., 50 miles), determining a second score for each resource based on a delay tolerance specified by the requester (e.g., ok to be 15 minutes late), and determining a third score for each resource based on an estimated ETA. The procedure 412 then averages the first, second, and third scores to determine a travel value. In some instances, the scores may be weighted using coefficients determined through feedback analysis and/or requester/resource feedback.

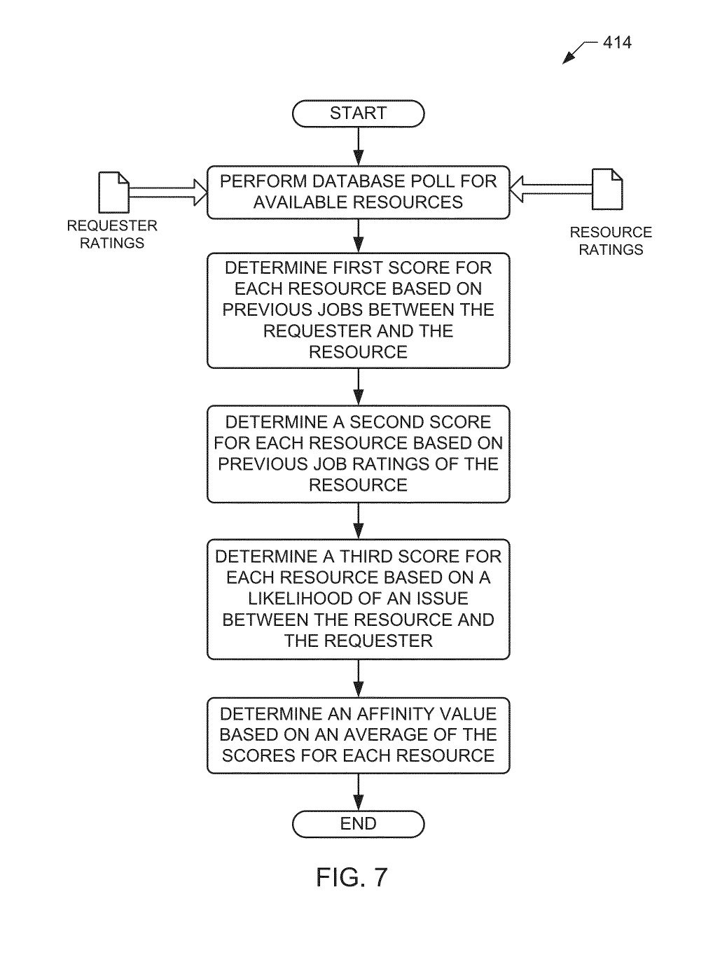

In a third thread (block 414) the server 102 determines an affinity value that corresponds to a probable simpatico match between the requester and the resource. The affinity value is based, in part, on requester ratings and/or resource ratings. FIG. 7 shows an exemplary procedure 414 to determine the affinity value, including, for example, accessing the rating information. The procedure 414 also includes determining a first score for each resource based on feedback from previous jobs between the requester and the resource, determining a second score for each resource based on previous job ratings of the resource, and determining a third score for each resource based on a likelihood of an issue between the resource and the requester. The third score may also be determined by reviewing feedback from the requester regarding other similar resources and determining how closely those resources match the resource under analysis. The third score may further be determined by reviewing ratings for the resource under analysis from other resources that are similar (e.g., similar type of requester, similar subject matter, etc.) to the requester. The procedure 414 then averages the first, second, and third scores to determine an affinity value. In some instances, the scores may be weighted using coefficients determined through feedback analysis and/or requester/resource feedback.

After determining the service value, the travel value, and the affinity value, the server 102 selects one or more resources that correspond to the highest values (block 416). In some instances, the server 102 averages the values and selects resources with an average value above a threshold. Alternatively the server 102 may compare each of the values for each resource to respective thresholds and only select resources with values that exceed the respective thresholds. Additionally or alternatively, the server 102 may select a top number of the resources (e.g., top 5).

Upon selecting resources that would provide a good match for the input criteria, the server 102 transmits a message identifying at least some of those resources to the requester (block 418). In some instances the server 102 may only transmit a message identifying the top matching resource. In other instances, the server 102 may transmit a message prompting the requester to select one of a plurality of top matching resources. The server 102 may include within the message the values determined for the resource, a requester-context version of the values (e.g., 5 stars corresponding to a relatively high service value), ratings of the resource, a profile of the resource, and/or feedback of the resource. In some alternative examples, the server 102 may transmit a job request to the highest matching resource prompting the resource to accept or decline the job request. In yet a further embodiment, the server 102 may transmit a broadcasted job request message to all qualifying matching resources within a specific distance from the job site. Then, after two minutes (or some other time), the best match that responded will receive the assignment and details.

In yet another embodiment, the server 102 may enable a requester to access a resource immediately via telephone, text, email, etc. For instance, a requester may need immediate access to a translator. After selecting a resource, the server 102 may prompt the requester if immediate access is needed. Upon receiving an affirmative response, the server 102 automatically connects the requester to the resource.

In the example embodiment of FIG. 4, the server 102 determines whether the requester has selected at least one of the resources (block 420). If an acceptance message is received, the server 102 may transmit a job offer to the selected resource and complete the transaction after receiving a job acceptance message from the resource. The procedure then ends. However, if the requester does not select one of the resources, the server 102 prompts the requester for additional information (e.g., input criteria) and/or to modify the provided criteria (block 422). The server 102 then returns to block 402 to begin the procedure 400 of selecting a resource.

### Information Database Embodiment

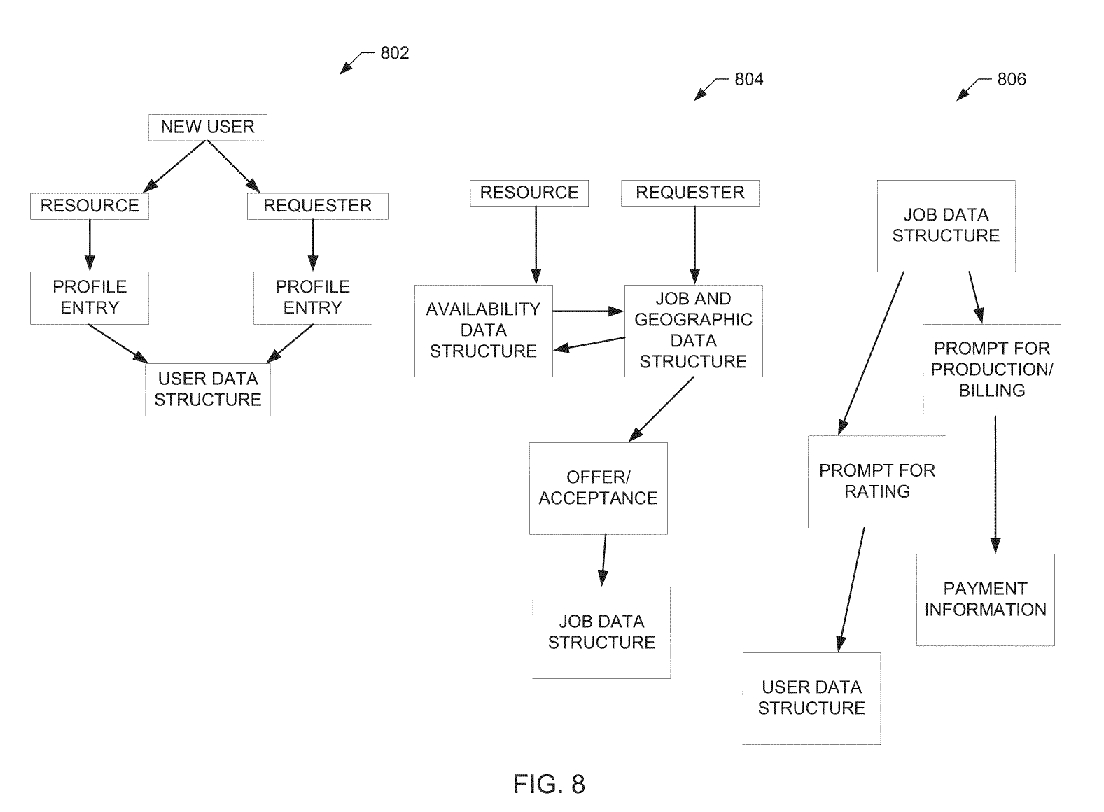

As discussed above, the server 102 uses various types of information within an availability algorithm to determine best matching resources. FIG. 8 shows a diagram of relationships between different data structures that are accessible by the server 102. The data structures may be stored in the database 114 or another database accessible by the server 102. Relationship 802 shows how resource and requester profile and attribute information is interrelated. For instance, resource information is stored to a resource profile entry and requester information is stored to a requester profile entry. Each of these profile entries are stored in a user data structure, which is accessed by the server 102 to determine which resources are available for any particular request.

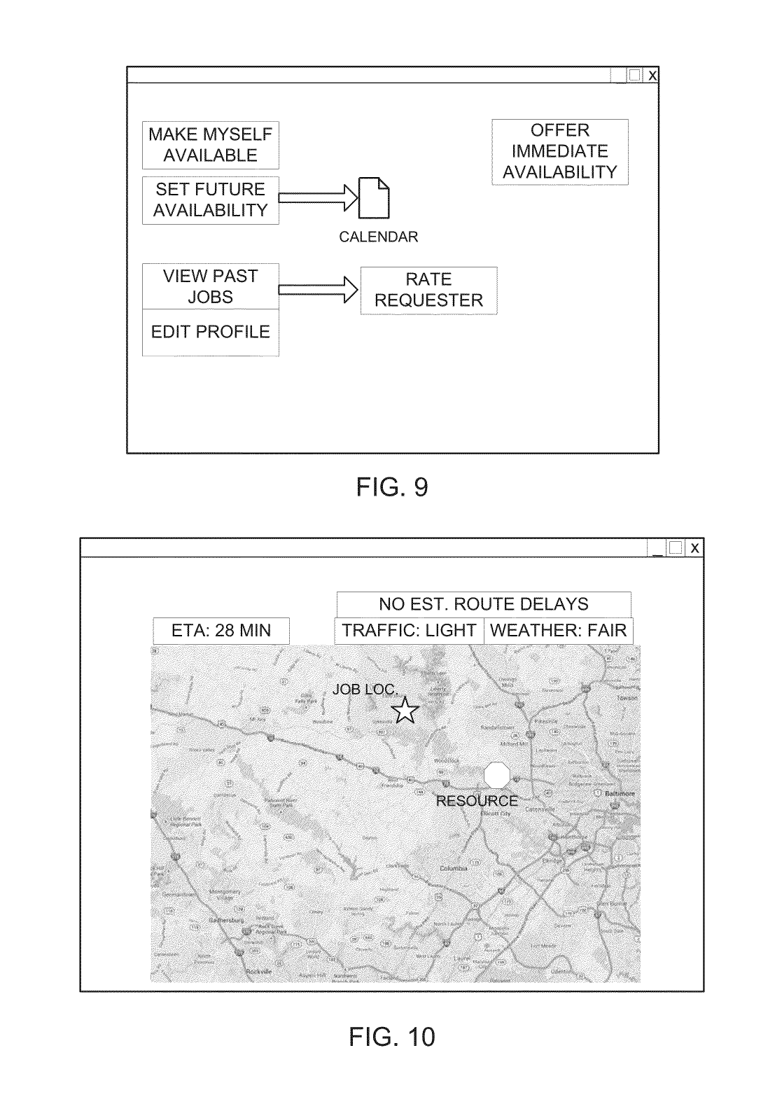

Relationship 804 shows data structure relationships when a requester submits a request and the server 102 determines best matching resources. For instance, the server 102 uses an availability data structure to identify which of the resources are available. A resource may use an interface to select when they are available, as shown in FIG. 9. The server 102 also uses a job and geographic data structure that stores information related to job details (e.g., resource type, date, etc.) and job location. The server 102 uses the availability data in conjunction with the job request and geographic data to select best matching resources as discussed above in conjunction with FIGS. 4 to 7.

The relationship 804 also includes a data structure that includes records of offers, acceptances, and any follow up information between the resource and requester including, for example, bid information, discounts awarded, concessions, additional services, etc. The relationship 804 also includes a job data structure that stores records of active, past, and future jobs including the details of the assignment, location, payment terms, etc.

Relationship 806 corresponds to data structure relationships for a job in progress. The server 102 may access the job data structure to prompt a requester and/or resource for production and/or billing information, which may be stored to the job data structure or a separate data structure with a link to the corresponding record in the job data structure. The server 102 may also process payment information for completed jobs in conjunction with the data within the job data structure and/or the production/billing information. Moreover, the server 102 may use the job data structure as a basis for prompting the requester and/or the resource for feedback and/or a rating, which may then be stored to the user data structure.

Regarding payments, the server 102 is configured to collect referral fees and/or a percentage of total amount invoiced from resources after a successful match and/or job acceptance. The server 102 may also determine total amounts to be charged, collect payment from requestors, and provide payment to resources/support agencies. Such a configuration streamlines the payment process. The server 102 may be configured to accept electronic payments through centralized and/or mobile payment platforms.

In some instances, the server 102 may determine when the resource arrives at an assignment location and accordingly charges the requester a fee. Then, for each increment of time that the resource is deployed at the assignment, as determined by the server 102, the server 102 charges the requester. The server 102 may determine that an assignment is completed by tacking the movement of the resource (e.g., away from the assignment location) and/or receiving a message from the resource indicating the assignment is completed (or the session has ended). The server 102 accordingly compiles the total charged for the assignment and sends the requester a bill (e.g., an electronic bill) or deducts the amount from an account of the requester. In some embodiments, the resource may use the server 102 to make a deliverable available for purchase from the requestor (or other individuals) and have the payment for such a transaction be processed through the server 102, a mobile application, and/or a third-party.

The server 102 may also maintain an ongoing relationship between a resource and a requester. For example, upon completion of a job, the server 102 may provide a resource with an option to contract with a support agency for at least some of the deliverable production process. This can include contracting that the support agency is to provide payment processing and invoicing, provide full-service transcript formatting, emailing, printing, and/or shipping services, and/or provide media digitization, duplication, distribution, and/or synchronization of video-transcript production services. Upon completion of a job, the server 102 enables the requestor to continue to use the same resource for a certain matter for convenience and familiarity factors using, for example, the user interface 300 of FIG. 3.

### Job Embodiment

As discussed above, the server 102 is configured to track a location of a resource in relation to a job site. The server 102 may make this information available to a requester in a requester-specific context. FIG. 10 shows a diagram of an exemplary context created by the server 102 for a requester. The context includes a map that shows a location of the job site and a current location of the resource. The server 102 may receive GPS coordinates from the resource device 106, per agreement of the resource, and determines an ETA of the resource to the job site based on the distance and information from third-parties. The server 102 may also provide the within the context third-party information such as weather or traffic conditions that may affect the ETA. The server 102 may further make the context available to the resource, an employer of the resource, and/or a support agency. The server 102 may also provide to the resource turn by-turn directions through this context upon request. The server 102 may change the context within some time period (e.g., 30 minutes) after determining the resource has arrived at the job site. For example, the server 102 may prompt the requester and/or the resource for feedback, ratings, etc.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the exemplary embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A system for provisioning resources, the system comprising:
a server configured to receive from a client device a request for a particular resource involving human manipulation of audio and/or visual information, the request including resource information pertaining to a type of the resource, a date/time at which the resource is needed, and a location where the resource is needed;
the server being further configured to evaluate respective criteria associated with each respective one of a plurality of potentially available resources to select one of the potentially available as a selected resource based on the respective criteria, send a client notification to the client device identifying the selected resource, and send to a device associated with the selected resource a resource notification indicating that the selected resource is selected as the particular resource.

2. The system according to claim 1, wherein
each of the respective criteria associated with a respective potentially available resource includes respective information about the respective potentially available resource pertaining to at least one of a relevance to the requested type of resource, an availability at the requested date/time, a geographical distance to the location and a rating.

3. The system according to claim 3, wherein
the server is configured to evaluate the respective criteria by comparing the respective information about each of the respective potentially available resources to one or more predetermined conditions to determine the respective information that best satisfies the at least one predetermined condition.

4. The system according to claim 1, wherein
the server is further configured to receive from the device associated with the selected resource a confirmation message in response to the resource notification.

5. The system according to claim 4, wherein
the server is further configured to confirm acceptance of the selected resource as the particular resource when the confirmation message indicates that the selected resource has accepted the being selected as the particular resource.

6. The system according to claim 4, wherein
the server is further configured to select another one of the potentially available resources as the selected resource based on the respective criteria when the confirmation message indicates that the selected resource has declined acceptance as the particular resource.

7. The system according to claim 1, wherein
the server is further configured to include in the client notification to the client device information pertaining to an estimated time of arrival of the selected resource at the location where the resource is needed.

8. The system according to claim 7, wherein
the server is further configured to estimate the time of arrival by estimating a travel time from a current location of the selected resource at the time of selection of the selected resource to the location where the resource is needed.

9. The system according to claim 1, wherein
the server is further configured to provide to the client device billing information associated with the particular resource subsequent to selection of the selected resource as the particular resource.

10. A non-transitory computer readable medium of instructions for controlling a computer to perform the following operations:
receive from a client device a request for a particular resource involving human manipulation of audio and/or visual information, the request including resource information pertaining to a type of the resource, a date/time at which the resource is needed, and a location where the resource is needed;
evaluate respective criteria associated with each respective one of a plurality of potentially available resources to select one of the potentially available resources as a selected resource based on the respective criteria;
send a client notification to the client device identifying the selected resource; and
send to a device associated with the selected resource a resource notification indicating that the selected resource is selected as the particular resource.

11. The non-transitory computer readable medium of instructions according to claim 11, wherein
each of the respective criteria associated with a respective potentially available resource includes respective information about the respective potentially available resource pertaining to at least one of a relevance to the requested type of resource, an availability at the requested date/time, a geographical distance to the location and a rating.

12. The non-transitory computer readable medium of instructions according to claim 12, wherein
the computer readable medium of instructions controls the computer to evaluate the respective criteria by comparing the respective information about each of the respective potentially available resources to one or more predetermined conditions to determine the respective information that best satisfies the at least one predetermined condition.

13. The non-transitory computer readable medium of instructions according to claim 10, wherein
the computer readable medium of instructions controls the computer to receive from the device associated with the selected resource a confirmation message in response to the resource notification.

14. The non-transitory computer readable medium of instructions according to claim 13, wherein
the computer readable medium of instructions controls the computer to confirm acceptance of the selected resource as the particular resource when the confirmation message indicates that the selected resource has accepted the being selected as the particular resource.

15. The non-transitory computer readable medium of instructions according to claim 13, wherein
the computer readable medium of instructions controls the computer to select another one of the potentially available resources as the selected resource based on the respective criteria when the confirmation message indicates that the selected resource has declined acceptance as the particular resource.

16. The non-transitory computer readable medium of instructions according to claim 10, wherein
the computer readable medium of instructions controls the computer to include in the client notification to the client device information pertaining to an estimated time of arrival of the selected resource at the location where the resource is needed.

17. The non-transitory computer readable medium of instructions according to claim 16, wherein
the computer readable medium of instructions controls the computer to estimate the time of arrival by estimating a travel time from a current location of the selected resource at the time of selection of the selected resource to the location where the resource is needed.

18. The non-transitory computer readable medium of instructions according to claim 10, wherein
the computer readable medium of instructions controls the computer to provide to the client device billing information associated with the particular resource subsequent to selection of the selected resource as the particular resource.

19. A method for provisioning resources, comprising:
receiving at a server a request from a client device for a particular resource involving human manipulation of audio and/or visual information, the request including resource information pertaining to a type of the resource, a date/time at which the resource is needed, and a location where the resource is needed;
evaluating at the server respective criteria associated with each respective one of a plurality of potentially available resources to select one of the potentially available resources as a selected resource based on the respective criteria;
send from the server a client notification to the client device identifying the selected resource; and
send from the server to a device associated with the selected resource a resource notification indicating that the selected resource is selected as the particular resource.

20. The method according to claim 1, wherein
each of the respective criteria associated with a respective potentially available resource includes respective information about the respective potentially available resource pertaining to at least one of a relevance to the requested type of resource, an availability at the requested date/time, a geographical distance to the location and a rating.
